(19) United States
(12) Patent Application Publication
(10) Pub. No.: US 2005/0276153 A1
(43) Pub. Date: Dec. 15, 2005

(54) Integrated control system

(75) Inventor: Benjamin Joseph Gordon, Ashville, OH (US)

Correspondence Address: BANNER & WITCOFF, LTD., TEN SOUTH WACKER DRIVE, SUITE 3000, CHICAGO, IL, 60606, US

(73) Assignee: Systech, Inc., Darien, IL (US)

(21) Appl. No.: 11/062,167

(22) Filed: Feb. 18, 2005

Related U.S. Application Data
(60) Provisional application No. 60/579,571, filed on Jun. 14, 2004.

(51) Int. Cl. B28C 7/00

(52) U.S. Cl. 366/6; 366/18

(57) ABSTRACT

The invention is directed to computer assisted manufacturing of industrial compositions, such as concrete. Aspects of the invention utilize wireless communications between a central processor and at least one field device having integrated circuitry. A process for initiating the automated preparation of concrete upon obtaining the weight of the solid ingredients is also disclosed.

### CROSS REFERENCE TO RELATED APPLICATIONS

This application claims the benefit of U.S. Provisional Application No. 60/579,571, filed on Jun. 14, 2004, the disclosure of which is herein incorporated by reference.

### FIELD OF THE INVENTION

Aspects of the invention relate to the computer assisted manufacturing of industrial compositions. More specifically, aspects of the invention concern a wireless integrated system for manufacturing industrial compositions, such as concrete.

### BACKGROUND OF THE INVENTION

A variety of computer controlled manufacturing devices and methods exist for producing industrial compositions. Generally, these systems utilize computers to monitor and/or diagnose the manufacturing process and end-product. In select systems, the process itself is adjusted through the use of computers. Typical automation systems comprise a central control system, databases, field devices, and user interfaces.

Early systems connected field devices to the control system by two-wire twisted pair loops, each device being connected to the control system by a single twisted pair producing an analog 4 to 20 mA input signal. A process controller comprised a centralized computer system located in the control room. This type of process control system is often referred to as Direct Digital Control (DDC). In the next phase of control system evolution, process controllers were decentralized into a plurality of computers throughout the factory or worksite in a Distributed Control System (DCS). These decentralized computers and a central computer located in the control room could be interconnected through a local data network or data bus, for example, whereas separate field devices remained connected to the process controllers through two-wire twisted pairs. More recent solutions have been adopted for the control systems, such as the Highway Addressable Remote Transducer (HART) protocol which allows digital data and a conventional analog 4 to 20 mA signal to be transmitted together in a twisted-pair loop. The next development phase involved a Field Control System (FCS) which employs a high-speed digital network or data bus for interconnecting the control room computer and the field devices. Conventional analog 4 to 20 mA signals have been omitted from the FCS, and a new communication protocol, commonly referred to as Fiedbus, has been defined by the Instruments Society of America (ISA). In most recent systems, field devices have been equipped with both a wireless and wired Fieldbus. The wireless connection is to serve as a secondary, redundant control path, instead of a secondary hardwired bus and to enable the field devices to be controlled directly by the service personnel using portable devices. In other systems designed for diagnostics, a wireless Fieldbus, alone, may be utilized, with the only cabling being for power and connection to local control systems, such as the circuitry needed to operate the device and receiving and transmitting diagnostic information to the central computer.

It is understood that various systems, however, have different capabilities as numerous systems are designed for specific applications and/or services. For example, a factory requiring diagnostic field devices for the production of nanotechnology-related products will vary greatly from a factory having field devices for manufacturing automobiles. Nonetheless, there exists a need to further increase the cost-efficiency of computer controlled manufacturing systems. For example, merely using wireless communications between processing computers and I/O junction boxes of field devices still requires extensive cabling to connect the I/O junctures to the field devices. Furthermore, automating the process upon the initiation of the first input is desirable.

Therefore, for these and other reasons, there remains a need by which a manufacturing process can be automated through a wireless communication system having integrated field devices.

### SUMMARY OF THE INVENTION

Aspects of the invention concerns a wireless integrated system for manufacturing industrial compositions, such as concrete. Aspects of the present invention provide for an apparatus and/or method of manufacturing concrete in a factory setting having integrated field devices connected through a wireless network. In one aspect of the invention, a process for manufacturing concrete is automatically calculated and initiated upon the quantifying of a first ingredient. In another aspect of the invention, field devices utilized for preparing the industrial composition have integrated I/O junctions. In yet another aspect of the invention, the field devices are controlled through a wireless network.

These and other features of the invention will be apparent upon consideration of the following detailed description of preferred embodiments.

### BRIEF DESCRIPTION OF THE DRAWINGS

The foregoing summary of the invention, as well as the following detailed description of preferred embodiments, is better understood when read in conjunction with the accompanying drawing, which is included by way of example, and not by way of limitation with regard to the claimed invention.

FIG. 1 illustrates a diagram of a wireless communication system in which various aspects of the present invention may be implemented.

FIG. 2 illustrates a flow diagram of an exemplary preparation method in accordance with one or more embodiments of the present invention.

### DETAILED DESCRIPTION OF THE PREFERRED EMBODIMENTS

Example Control System

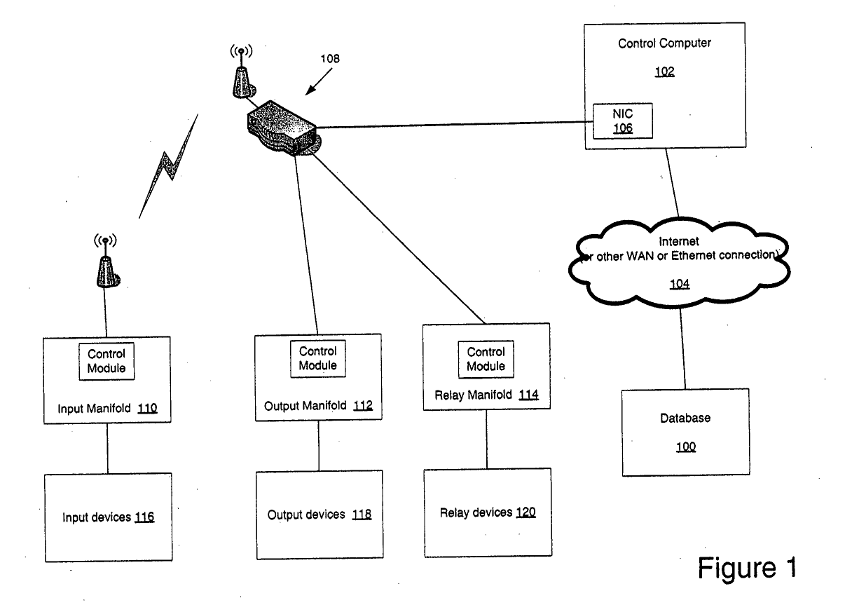

FIG. 1 illustrates one embodiment of the invention. A database 100 may store recipes and formulas necessary for producing the end product of the process, batching parameters that determine the process flow and control points, and batch result information for process analysis and verification. In some embodiments of the invention, database 100 may store additional customer related information, such as for example, billing information. Database 100 is shown connected to a control computer 102 via the Internet 104. The configuration shown in FIG. 1 allows database 100 to be located at a customer's premise or location distant from control computer 102. Of course, database 100 may be located within control computer 102 or connected to control computer 102 via a local Ethernet connection, such as a local area network. Database 100 may also be implemented with a computer device.

Control computer 102 may be implemented with a standard desktop PC running control software and may include a touch screen application for manual control of the various devices involved in the process being controlled. Control computer 102 may also include a network interface card or module 106 for communicating with an input manifold 110, an output manifold 112 and/or a relay manifold 114 via a router 108. In preferred embodiments, each of the manifolds 110, 112, 114 may comprise a pneumatic manifold. In such preferred embodiments, each pneumatic manifold includes a control unit that receives electrical signals and causes the pneumatic manifold to produce a pneumatic output. Such pneumatic manifolds are commercially available from a variety of vendors, such as Parker-Hannifin Corporation, Cleveland, Ohio. In other embodiments, the manifolds 110, 112, 114 comprise a plurality of pneumatic devices. In the exemplary embodiment, the pneumatic manifold 114 can trigger a relay to activate an electrical, mechanical, or electromechanical device, such as a horn, lever, or light source. Of course, it is within the scope of the invention that additional or fewer pneumatic manifolds may be used in alternative embodiments. Among other advantages, the usage of an integrated manifold eliminates the requirement of using an I/O junction box, minimizes (or eliminates) the need for wiring between the control system and the devices that it controls, and may provide for a far more intelligent and responsive control system. For example, in preferred embodiments, an integrated manifold can detect the response time for the moment an instruction is relayed to a device, to the moment the instruction is received, processed, and/or completed. This inherent intelligence can then be utilized by the system to enhance control of that device, and/or provide management information, such as, for example, safety warnings or maintenance requests. In further embodiments, the system could utilize the intelligence to incorporate a built-in redundancy. For example, altering the activation state of a malfunctioning device to off-line and activating a replacement.

Router 108 may be coupled to or include a wireless access point for communicating with one or more pneumatic manifolds. A single cable with two twisted pairs of conductors may connect control computer 102 to router 108 to provide all of the communication necessary for controlling an almost unlimited number of devices under this scheme. This compares to a dedicated pair of wires for the control of each device (the number of devices can easily exceed 100) in conventional configurations. Because the I/O communication methods utilized by these pneumatic manifolds may be digital industry standards, the control system can also communicate via wireless networks and totally eliminate the need for any form of cabling between the control system and the devices that they control. This is an important feature relative to on-going plant maintenance due to the tendency of wires and connections to work loose from vibrations, temperature changes, and the like, while also enhancing lightning protection.

It is within the scope of the present invention to use either analog or digital communications protocols, or each in conjunction with another. Exemplary digital industry standard communication protocols that may be used with aspects of the invention include: Ethernet I/O., DeviceNet, ControlNet, PROFIBUS, Remote I/O (RIO), or any other adaptable communications protocol.

As discussed above, each pneumatic manifold may be coupled to one or more pneumatic devices. In preferred embodiments, input devices 116 may include devices that are read.

Output devices 118 may include devices that can be turned on and off. Relay devices 120 may include devices that a pneumatic valve may activate, such as horns and lights.

Some devices may include electrical relays or electronic I/O units that are commercially available from many vendors, including Allen Bradley, Milwaukee, Wis.

Example Preparation Method

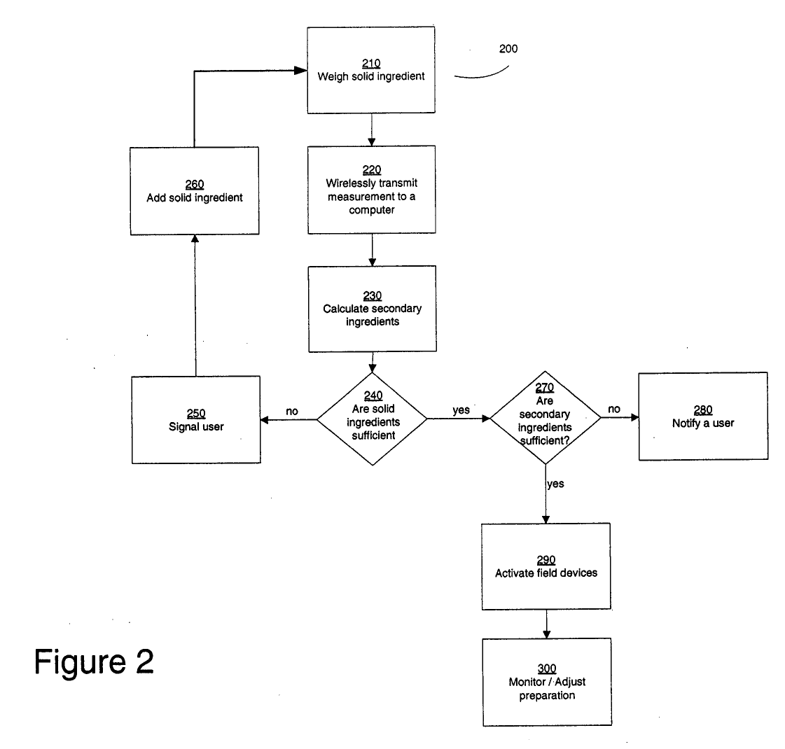

FIG. 2 is a flow diagram of an exemplary preparation method in accordance with one or more embodiments of the present invention. In a process 200 utilizing an apparatus in accordance with the present invention, the manufacturing process is automatically calculated and initiated by the quantifying of a first ingredient. In preferred embodiments, one or more solid ingredients of concrete are weighed in a scale device at step 210. In other embodiments, however, liquid ingredients are first weighed. A suitable scale device as contemplated by the present invention is well-known in the art and may be obtained by, for example, Mettler Toledo Inc., of Columbus, Ohio. In yet other embodiments, additional physical or chemical parameters of the solid ingredients are computed, such as, for example, moisture or mineral content.

The weight of the solid ingredients and/or other values obtained by the measuring device are wirelessly transmitted to a computer (step 220). Step 230 then calculates the appropriate type and amount of additional ingredients to mix with the solid ingredients. In one embodiment, the calculations are derived from a predetermined algorithm, however, manually entered formulas are also within the scope of the present invention. In yet additional embodiments, optional step 240 may determine if the amount of solid ingredient(s) on the scale is insufficient to prepare a batch of concrete. In the event there is not enough solid ingredient to prepare the concrete, step 250 may signal a user of the shortage. Yet in other embodiments, step 260 may be incorporated to add the requisite solid ingredients. If enough solid ingredients are present in step 240, the computer may signal that, based upon the amount of solid ingredient(s), there are insufficient amounts of secondary ingredients to prepare a batch of concrete (steps 270-280). Optionally, step 280 may calculate alternative recipes that may be formulated based upon the available types and amounts of ingredients.

If, based upon the computer's calculations, there are enough initial and secondary ingredients; the appropriate field devices are wirelessly activated (step 290). Exemplary field devices could include pneumatic manifolds to add ingredients, mixers, heating components, or other field devices utilized to manufacture the industrial composition. The field devices used in conjunction with the manufacturing processes of the present invention comprise integrated circuitry. In preferred processes, the devices comprise pneumatic manifolds as contemplated above. Step 300 may optionally monitor the preparation of the concrete, allowing for the automatic addition of ingredients as needed.

It is within the scope of the invention to incorporate a stackable manifold arrangement as disclosed in U.S. Pat. No. 6,701,962 and devices and methods to incorporate redundancy in the control system as disclosed in U.S. Pat. No. 6,742,136. Both patents are hereby incorporated by reference.

While illustrative systems and methods as described herein embodying various aspects of the present invention are shown by way of example, it will be understood, of course, that the invention is not limited to these embodiments. Modifications may be made by those skilled in the art, particularly in light of the foregoing teachings. For example, each of the elements of the aforementioned embodiments may be utilized alone or in combination with elements of the other embodiments. Also, the invention has been defined using the appended claims; however these claims are exemplary in that the invention is intended to include the elements and steps described herein in any combination or sub-combination. It will also be appreciated and understood that modifications may be made without departing from the true spirit and scope of the invention.

1. A method for preparing concrete, the method comprising the steps of:
quantifying an amount of a first ingredient;
receiving wirelessly the amount;
computing a secondary amount of secondary ingredients to mix with said initial ingredient; and
activating wirelessly at least one field device, said field device having integrated circuitry, wherein activation of at least one field device initiates the addition of the secondary amount of the secondary ingredients.

2. The method of claim 1, wherein the secondary ingredients comprise liquids.

3. The method of claim 1, wherein at least one field device comprises a pneumatic manifold.

4. The method of claim 1, wherein at least one field device comprises a plurality of pneumatic devices.

5. The method of claim 3, wherein at least one field device comprises at least one pneumatic manifold selected from the group consisting of an input manifold, a relay manifold, and an output manifold.

6. The method of claim 4, wherein a pneumatic device rests in a hibernation state and activates upon the malfunction of at least one second pneumatic device.

7. The method of claim 1, further comprising the step of allowing the continuous adjustment of the composition preparation process through the use wireless communications between the field device.

8. The method of claim 1, further comprising the step of computing the batch result information.

9. A system for preparing concrete utilizing wireless communication, the system comprising:
a scale for automatically weighing at least one solid ingredient;
a wireless device in communication with the scale to transmit the weight of at least one solid ingredient;
a processor in communication with the wireless device for receiving the weight of at least one solid ingredient and calculating an effective amount of liquid ingredients to combine with the solid ingredients; and
at least one field device for combining at least one solid ingredient with the liquid ingredients, at least one field device having integrated circuitry, wherein the field device is wirelessly activated.

10. The system of claim 9, wherein at least one field device comprises a pneumatic manifold.

11. The system of claim 10, wherein at least one field device comprises a plurality of pneumatic devices.

12. The system of claim 11, wherein at least one field device comprises at least one pneumatic manifold selected from the group consisting of an input manifold, a relay manifold, and an output manifold.

13. The method of claim 10, wherein a pneumatic device rests in a hibernation state and activates upon the malfunction of at least one second pneumatic device.

14. A method for preparing a concrete composition, the method comprising the steps of:
quantifying at least one solid ingredient to obtain a result;
receiving wirelessly the result into a computer;
computing an appropriate amount and type of secondary ingredients to combine with the solid ingredient;
determining if the computed amounts and types of secondary ingredients are available; and
wirelessly activating at least one field device, the field device having integrated circuitry, wherein activation of the field device initiates the addition of the secondary ingredients.

15. The method of claim 14, further comprising the step of allowing the continuous adjustment of the composition preparation process through the use wireless communications.

16. The method of claim 14, further comprising the step of computing an alternative concrete composition based upon the available ingredients.

17. The method of claim 14, wherein at least one field device comprises a pneumatic manifold.

18. The method of claim 14, wherein a field device comprises at least one pneumatic manifold selected from the group consisting of an input manifold, a relay manifold, and an output manifold.

19. The method of claim 18, wherein a pneumatic device rests in a hibernation state and activates upon the malfunction of at least one second pneumatic device.

20. The method of claim 14, further comprising the step of computing the batch result information.
